(19) United States
(12) Patent Application Publication
(10) Pub. No.: US 2023/0180050 A1
(43) Pub. Date: Jun. 8, 2023

(54) AUTOMATED PROCESSING ALLOCATION FOR QoS-SPECIFIC COMMUNICATIONS

(71) Applicants: AT&T Intellectual Property I, L.P., Atlanta, GA (US); AT&T Mobility II LLC, Atlanta, GA (US)

(72) Inventors: Sheldon Kent Meredith, Roswell, GA (US); Mark Austin, Allen, TX (US); Zachary Meredith, Roswell, GA (US)

(73) Assignees: AT&T Intellectual Property I, L.P., Atlanta, GA (US); AT&T Mobility II LLC, Atlanta, GA (US)

(21) Appl. No.: 17/541,899

(22) Filed: Dec. 3, 2021

(51) Int. Cl. H04W 28/02; H04L 43/0852; H04L 43/0864

(52) U.S. Cl. CPC H04W 28/0268; H04L 43/0858; H04L 43/0864

(57) ABSTRACT

Aspects of the subject disclosure may include, for example, obtaining first quality-of-service (QoS) information associated with a first communication session between a first communication device and a radio element of a wireless network, the first communication session comprising a first communication that is transmitted from the first communication device to the radio element; determining, based at least in part upon the first QoS information, whether the first communication is to be processed by one or more first servers of an edge node of a packet core network, the determining resulting in a first determination; responsive to the first determination being that the first communication is to be processed by the one or more first servers of the edge node, directing the first communication from the radio element to the edge node, the directing of the first communication to the edge node facilitating a providing of a first latency to the first communication; and responsive to the first determination being that the first communication is not to be processed by the one or more first servers of the edge node, directing the first communication from the radio element to one or more second servers of another node of the packet core network, the directing of the first communication to the another node facilitating a providing of a second latency to the first communication. Other embodiments are disclosed.

### FIELD OF THE DISCLOSURE

The subject disclosure relates to automated processing allocation for QoS-specific communications.

### BACKGROUND

A conventional concept in certain mobile radio networks relates to QoS-based bearer types. Typically, in modern mobile radio networks, when a mobile device requests radio resources to support a communication, the mobile device declares the type of communication as a QoS (quality-of-service) class. A similar conventional QoS class concept exists in broadband wired networks with SD-WAN (Software Defined Wide Area Networks). Such QoS classes can include voice communications (typically latency-intolerant and error-tolerant), streaming (latency-tolerant and error-tolerant), interactive background (somewhat latency-tolerant and error-intolerant), and gaming (latency-intolerant and error-intolerant). Indeed, even within (for example) gaming applications there can be some multiple data streams with different latency needs, such as User Data Protocol (UDP) streams for conveying the very low latency gaming control functions and other Transmission Control Protocol/Internet Protocol (TCP-IP) streams with less low latency needs. Further, file transfer and email communications can be considered as very latency-tolerant while still being error-intolerant. In addition, a QoS type can be conceived that is latency-intolerant and error-tolerant.

When a device requests radio resources, certain conventional allocations focus on the error-tolerance required. Latency is essentially established by the locations of processing servers and the time-delays in the transport networks for signaling or content delivery. Queueing of communications among multiple-access users can be manipulated to reduce latency for some users, but transport delays are the dominant factor in device-perceived latency and therefore, user-experience.

Further, computer processing costs for groups of servers vary due to economies of scale. Centralized processing typically provides lowest costs by optimizing floor space, maintenance labor, administration systems, power and cooling systems, etc. Distributed “Edge Processing” allows processing to occur closer to connected communication devices, lowering latency, but at higher costs.

In this regard, low-latency communications, demanding edge-computing closer to the device, are necessarily more expensive to provide. The advent of 4G/5G communications systems has compelled an architectural shift in communications networks towards edge-processing and higher costs. This is due to a fundamental architectural problem where all communications in such 4G/5G communications systems are typically processed as close to the edge as possible.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network in accordance with various aspects described herein.

FIG. 2A is a block diagram illustrating an example, non-limiting embodiment of a system (that can function fully or partially within the communication network of FIG. 1) in accordance with various aspects described herein.

FIG. 2B is a block diagram illustrating an example, non-limiting embodiment of a system (that can function fully or partially within the communication network of FIG. 1) in accordance with various aspects described herein.

FIG. 2C depicts an illustrative embodiment of a method in accordance with various aspects described herein.

FIG. 2D depicts an illustrative embodiment of a method in accordance with various aspects described herein.

FIG. 2E depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for allocating resources (e.g., nodes in a network) and directing communications to certain node(s). Other embodiments are described in the subject disclosure.

One or more aspects of the subject disclosure include a mechanism that can utilize a declared QoS type that is found in a request from a device (the request from the device being, for example, a request to allocate a radio bearer for communications). In one example, a request for a communication resource can be analyzed by an edge node, which can then process the request or redirect the request to an intermediate node or a centralized node. The QoS can be used to determine the optimum server location for processing the communication. The optimum server location can be based upon: (a) historically measured latencies to/from various locations; and/or (b) predicted costs (e.g., including network transport costs). In various examples, the QoS types that can be processed at a low-cost location are sent to the least expensive location that meets the QoS latency requirements. In various examples, a mechanism enables a network operator to dynamically adjust the routing rules to adjust costs (e.g., as a function of network loading and/or time of day/day of week).

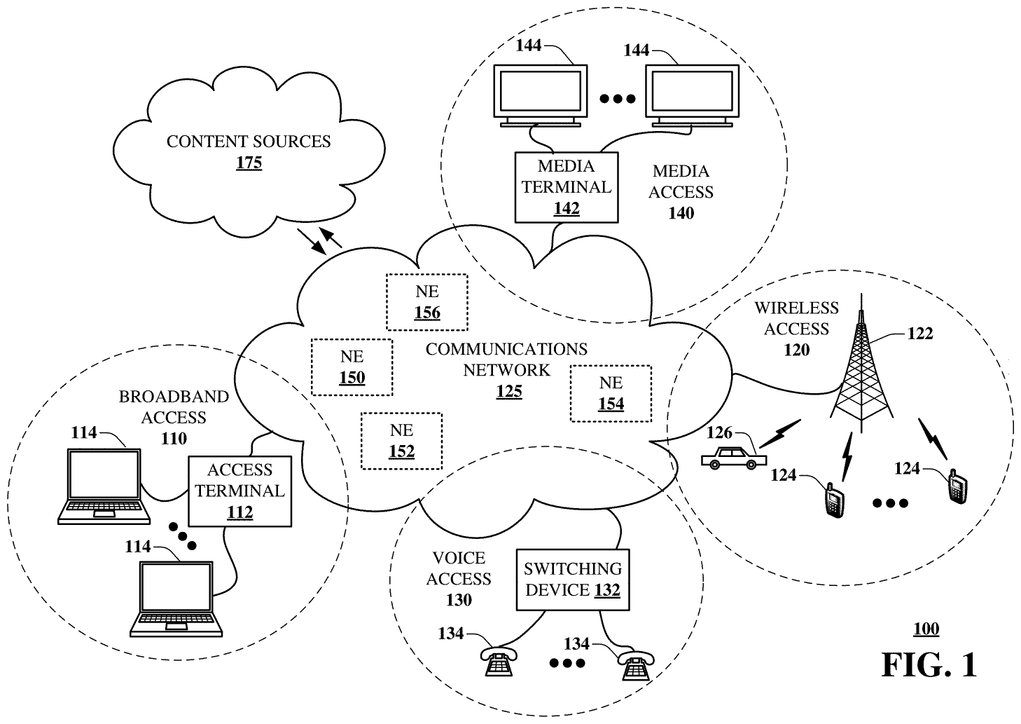

Referring now to FIG. 1, a block diagram is shown illustrating an example, non-limiting embodiment of a system 100 in accordance with various aspects described herein. For example, system 100 can facilitate in whole or in part automatic allocation of one or more resources (e.g., one or more computer server resources at a particular network node) to a communication in accordance with a quality-of-service parameter associated with the communication. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

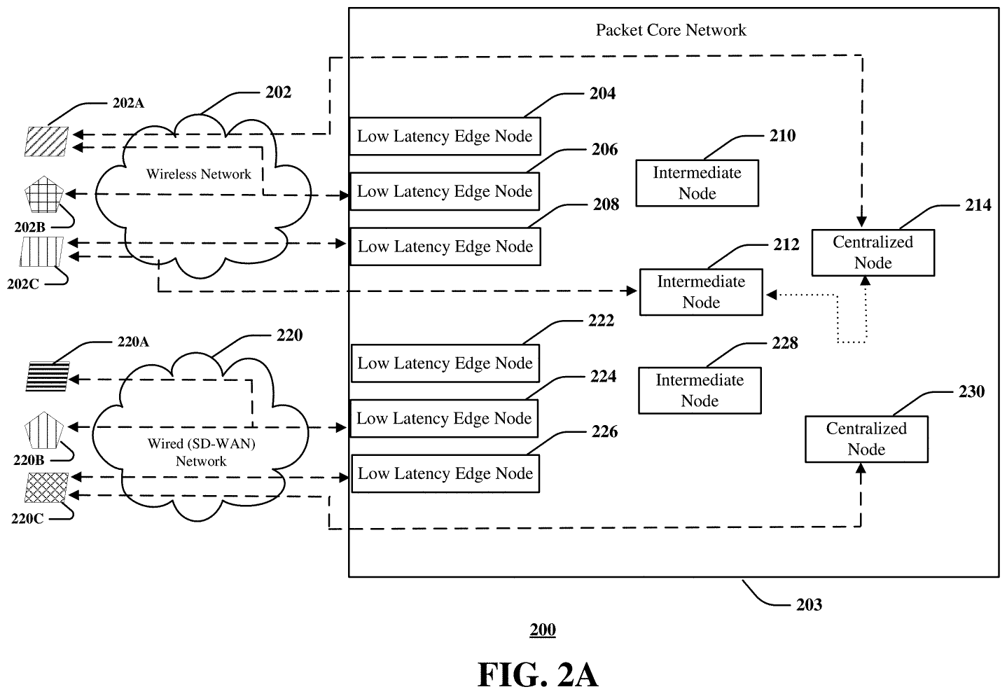

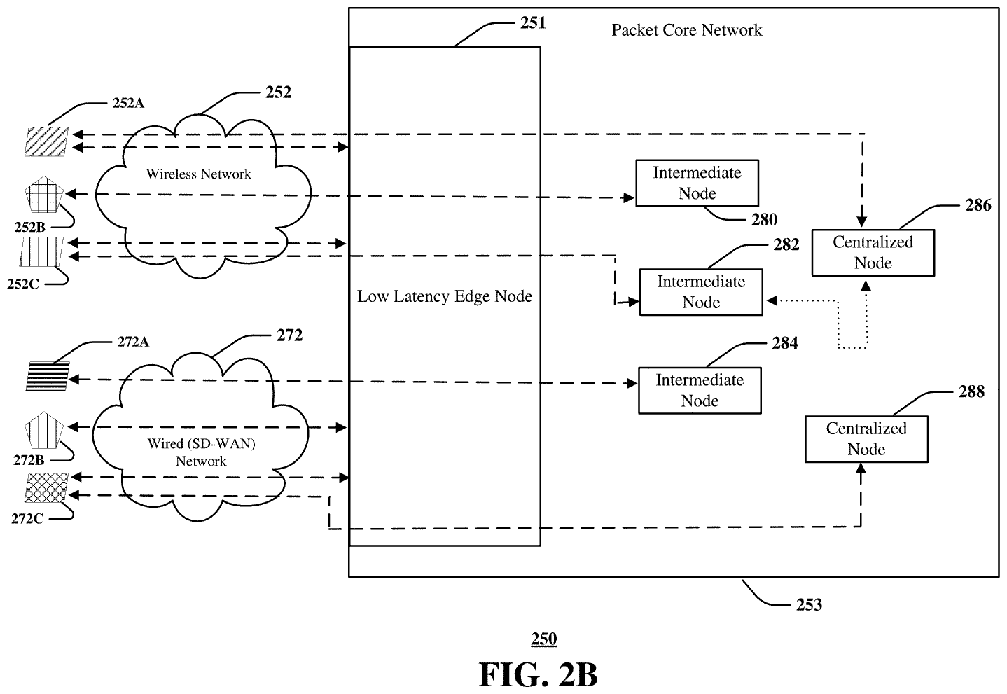

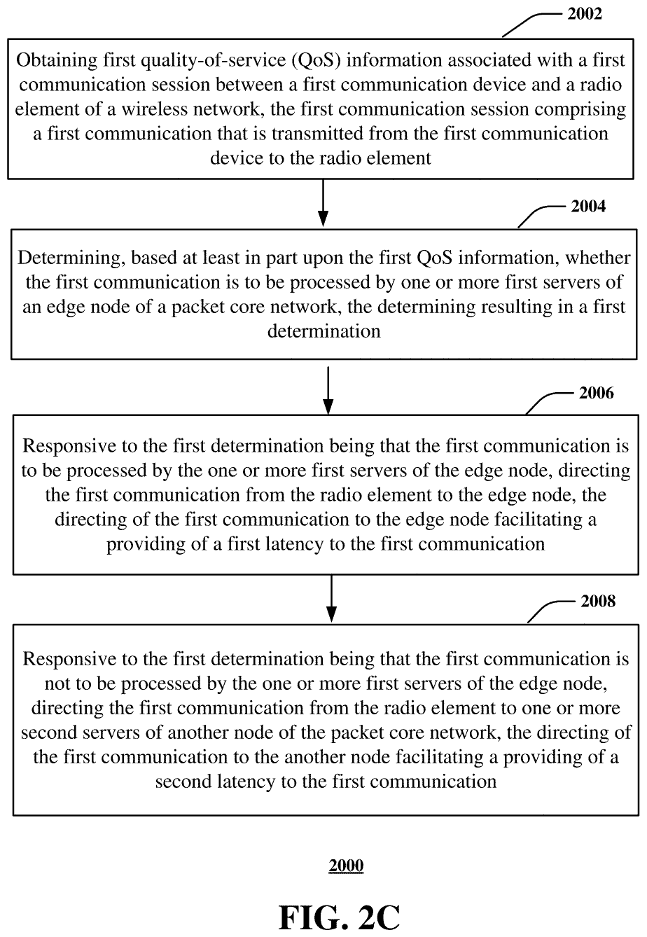

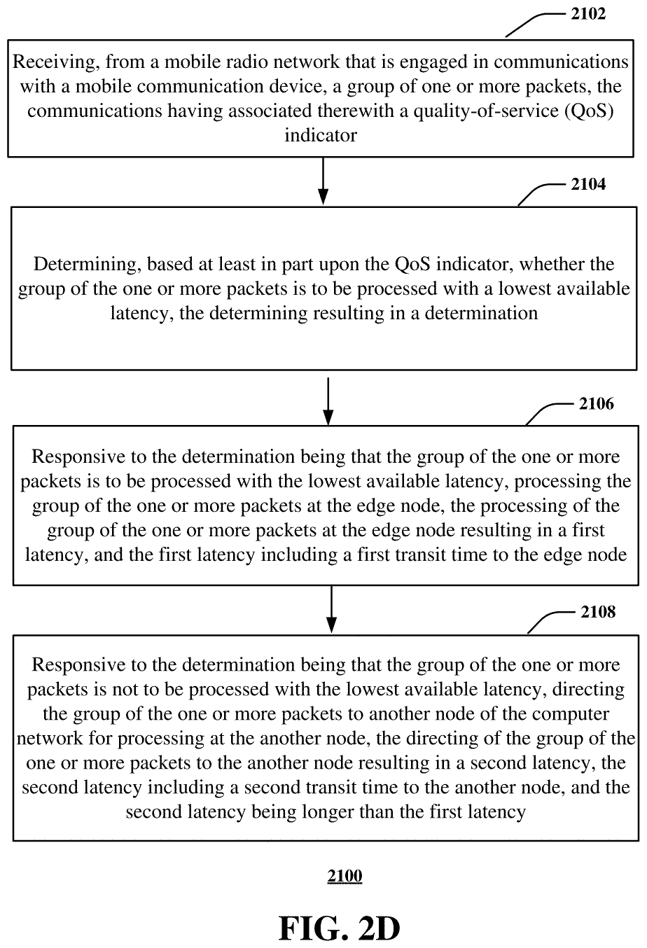

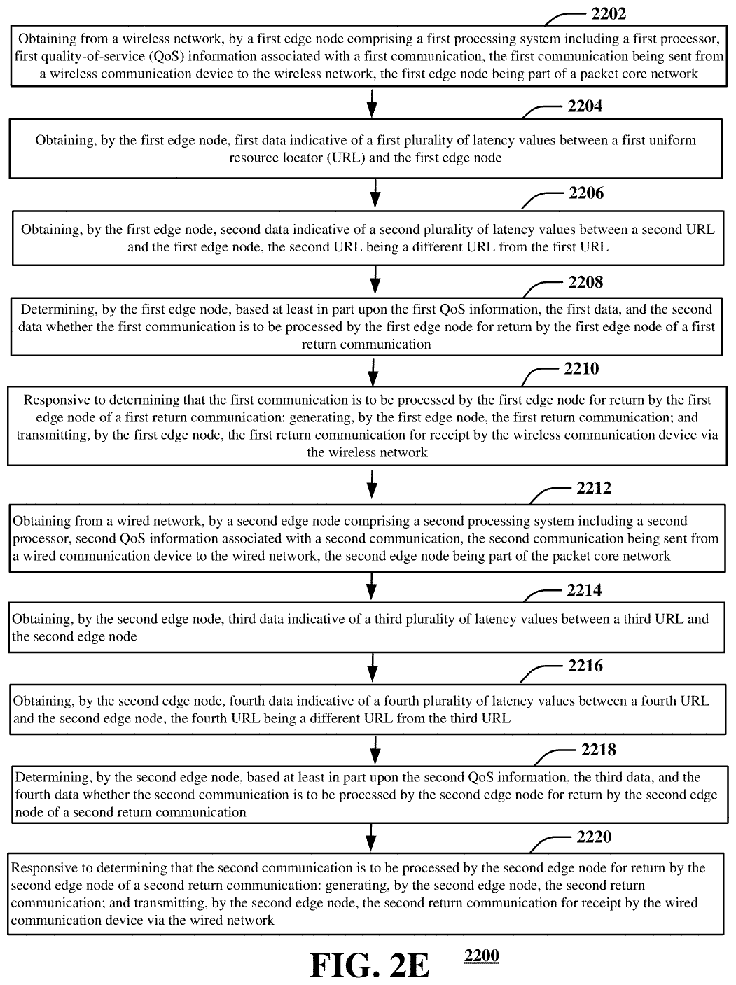

Referring now to FIG. 2A, this is a block diagram illustrating an example, non-limiting embodiment of a system 200 (that can function fully or partially within the communication network of FIG. 1) in accordance with various aspects described herein. As seen in this figure, wireless network 202 (which can include one or more radio elements, such as cell sites and/or other access points (not shown), and one or more servers (not shown)) can be in bi-directional communication with mobile communication devices 202A, 202B, 202C. Each of mobile communication devices 202A, 202B, 202C (via wireless network 202) can send one or more communications to and receive one or more communications from one or more of Nodes 204, 206, 208, 210, 212, 214 of Packet Core Network 203. In this regard, the wireless communication network 202 can dynamically decide (e.g., using the one or more radio elements thereof and/or the one or more servers thereof) for each of mobile communication devices 202A, 202B, 202C to which of Nodes 204, 206, 208, 210, 212, 214 a given communication should be directed. The decisions made by the wireless communication network 202 as to routing can be based, for example, upon at least one quality-of-service parameter associated with each of the communications. In various examples, an edge node can be characterized by computer(s), server(s), or any combination thereof within an enterprise complex such as a stadium, building, airport, train station, a housing community, a university campus, or any geographic area for which mobile radio coverage would be topologically grouped and usually covering an area of a large town. In various examples, an intermediate node can be characterized by computer(s), server(s), or any combination thereof handling radio coverage for mobile devices in an area typically encompassing multiple small cities (like Tampa and Orlando) or a single large city such as NYC or Los Angeles. In various examples, a centralized node can be characterized by computer(s), server(s), or any combination thereof addressing radio coverage in an area typically considered as a geographic region such as the Northeast US, Southeast US, Midwest US, Northwest US, Southwest US, or South Central US.

Still referring to FIG. 2A, it is seen that in this example, communications associated with mobile communication device 202A are routed to/from Centralized Node 214 (these communications can, for example, be latency-tolerant). Further, in this example, other communications associated with mobile communication device 202A are routed to/from Edge Node 206 (these communications can, for example, be latency-intolerant). Further still, in this example, communications associated with mobile communication device 202B are routed to/from Edge Node 206 (these communications can, for example, be latency-intolerant). Further still, in this example, communications associated with mobile communication device 202C are routed to/from Edge Node 208 (these communications can, for example, be latency-intolerant). Further still, in this example, other communications associated with mobile communication device 202C are routed to/from Intermediate Node 212 (these communications can, for example, be somewhat latency-tolerant, but more latency-intolerant than, for example, the communications between mobile device 202A and Centralized Node 214.). Further still, in one embodiment, communications received at Intermediate Node 212 can be redirected to/from Centralized Node 214 (see the dotted arrow connecting these two nodes). In various examples, latency-intolerant can mean that a latency up to a certain first threshold (which first threshold can be pre-determined based upon one or more factors including QoS, type of service, type of application, etc.) is acceptable, somewhat latency-tolerant can mean that a latency up to a certain second threshold (which second threshold can be higher than the first threshold and can be pre-determined based upon one or more factors including QoS, type of service, type of application, etc.) is acceptable, and latency-tolerant can mean that a latency up to a certain third threshold (which third threshold can be higher than the first and second thresholds and can be pre-determined based upon one or more factors including QoS, type of service, type of application, etc.) is acceptable. In various specific examples, the first threshold (corresponding to latency-intolerant) can be 25 milliseconds, the second threshold (corresponding to somewhat latency-intolerant) can be 50 milliseconds, and the third threshold (corresponding to latency-tolerant) can be 100 milliseconds.

Still referring to FIG. 2A, it is seen that wired (SD-WAN) Network 220 (which can include one or more servers (not shown)) can be in bi-directional communication with communication devices 220A, 220B, 220C. Each of communication devices 220A, 220B, 220C (via wired network 220) can send one or more communications to and receive one or more communications from one or more of Nodes 222, 224, 226, 228, 230. In this regard, the wired communication network 220 can dynamically decide (e.g., using the one or more servers thereof) for each of communication devices 220A, 220B, 220C to which of Nodes 222, 224, 226, 228, 230 of Packet Core Network 203 a given communication should be directed. The decisions made by the wired network 220 as to routing can be based, for example, upon at least one quality-of-service parameter associated with each of the communications.

Still referring to FIG. 2A, it is seen that in this example, communications associated with communication device 220A are routed to/from Edge Node 224 (these communications can, for example, be latency-intolerant). Further, in this example, communications associated with communication device 220B are routed to/from Edge Node 224 (these communications can, for example, be latency-intolerant). Further still, in this example, communications associated with communication device 220C are routed to/from Edge Node 226 (these communications can, for example, be latency-intolerant). Further still, in this example, other communications associated with communication device 220C are routed to/from Centralized Node 230 (these communications can, for example, be latency-tolerant).

Still referring to FIG. 2A, it is noted that in this example, each of Centralized Nodes 214, 230 has relatively higher latency (as compared to the other nodes) and has relatively lower processing cost (as compared to the other nodes). Further, in this example, each of Intermediate Nodes 210, 212, 228 has relatively moderate latency (as compared to the other nodes) and has relatively moderate processing cost (as compared to the other nodes). Further still, in this example, each of Edge Nodes 204, 206, 208, 222, 224, 226 has relatively smaller latency (as compared to the other nodes) and has relatively higher processing cost (as compared to the other nodes).

In another embodiment, each of the Edge Nodes 204, 206, 208, 222, 224, 226 detects a respective OoS and directs a respective device to establish one or more data sessions with an appropriate hierarchical node level.

Of course, while three mobile communication devices are shown in this FIG. 2A, any desired number of mobile communication devices can be supported. Further, while three (non-mobile) communication devices are shown in this FIG. 2A, any desired number of (non-mobile) communication devices can be supported. Further still, any desired number of Low Latency Edge Nodes can be supported, any desired number of Intermediate Nodes can be supported, and any desired number of Centralized Nodes can be supported.

Referring now to FIG. 2B, this is a block diagram illustrating an example, non-limiting embodiment of a system 250 (that can function fully or partially within the communication network of FIG. 1) in accordance with various aspects described herein. As seen in this figure, wireless network 252 (which can include one or more radio elements, such as cell sites and/or other access points (not shown), and one or more servers (not shown)) can be in bi-directional communication with mobile communication devices 252A, 252B, 252C. Each of mobile communication devices 252A, 252B, 252C (via wireless network 252) can send one or more communications to and receive one or more communications from Edge Node 251 of Packet Core Network 253. In this regard, the Edge Node 251 can dynamically decide (e.g., using one or more servers thereof) for each of mobile communication devices 252A, 252B, 252C whether to process communications at the Edge Node 251 itself or to route the communications to one or more of Nodes 280, 282, 284, 286, 288 of Packet Core Network 253. The decisions made by the Edge Node 251 as to routing (or processing at the Edge Node 251) can be based, for example, upon at least one quality-of-service parameter associated with each of the communications.

Still referring to FIG. 2B, it is seen that in this example, communications associated with mobile communication device 252A are routed (through Edge Node 251) to/from Centralized Node 286 (these communications can, for example, be latency-tolerant). Further, in this example, other communications associated with mobile communication device 252A are processed at Edge Node 251 (these communications can, for example, be latency-intolerant). Further still, in this example, communications associated with mobile communication device 252B are routed (through Edge Node 251) to/from Intermediate Node 280 (these communications can, for example, be somewhat latency-tolerant, but more latency-intolerant than, for example, the communications between mobile device 252A and Centralized Node 286). Further still, in this example, communications associated with mobile communication device 252C are processed at Edge Node 251 (these communications can, for example, be latency-intolerant). Further still, in this example, other communications associated with mobile communication device 252C are routed (through Edge Node 251) to/from Intermediate Node 282 (these communications can, for example, be somewhat latency-tolerant, but more latency-intolerant than, for example, the communications between mobile device 252A and Centralized Node 286). Further still, in one embodiment, communications received at Intermediate Node 282 can be redirected to/from Centralized Node 286 (see the dotted arrow connecting these two nodes).

Still referring to FIG. 2B, it is seen that wired (SD-WAN) Network 272 (which can include one or more servers (not shown)) can be in bi-directional communication with communication devices 272A, 272B, 272C. Each of communication devices 272A, 272B, 272C (via wired network 272) can send one or more communications to and receive one or more communications from Edge Node 251 Packet Core Network 253. In this regard, the Edge Node 251 can dynamically decide (e.g., using one or more servers thereof) for each of communication devices 272A, 272B, 272C whether to process communications at the Edge Node 251 itself or to route the communications to one or more of Nodes 280, 282, 284, 286, 288 of Packet Core Network 253. The decisions made by the Edge Node 251 as to routing (or processing at the Edge Node 251) can be based, for example, upon at least one quality-of-service parameter associated with each of the communications.

Still referring to FIG. 2B, it is seen that in this example, communications associated with communication device 272A are routed (through Edge Node 251) to/from Intermediate Node 284 (these communications can, for example, be somewhat latency-tolerant). Further, in this example, communications associated with communication device 272B are processed at Edge Node 251 (these communications can, for example, be latency-intolerant). Further still, in this example, communications associated with communication device 272C are processed at Edge Node 251 (these communications can, for example, be latency-intolerant). Further still, in this example, other communications associated with communication device 272C are routed (through Edge Node 251) to/from Centralized Node 280 (these communications can, for example, be latency-tolerant).

Still referring to FIG. 2B, it is noted that in this example, each of Centralized Nodes 286, 288 has relatively higher latency (as compared to the other nodes) and has relatively lower processing cost (as compared to the other nodes). Further, in this example, each of Intermediate Nodes 280, 282, 284 has relatively moderate latency (as compared to the other nodes) and has relatively moderate processing cost (as compared to the other nodes). Further still, in this example, Edge Node 251 has relatively smaller latency (as compared to the other nodes) and has relatively higher processing cost (as compared to the other nodes).

In another embodiment, the Edge Node 251 detects a respective OoS and directs a respective device to establish one or more data sessions with an appropriate hierarchical node level.

Of course, while three mobile communication devices are shown in this FIG. 2B, any desired number of mobile communication devices can be supported. Further, while three (non-mobile) communication devices are shown in this FIG. 2B, any desired number of (non-mobile) communication devices can be supported. Further still, any desired number of Low Latency Edge Nodes can be supported, any desired number of Intermediate Nodes can be supported, and any desired number of Centralized Nodes can be supported.

Referring now to FIG. 2C, various steps of a method 2000 according to an embodiment are shown. As seen in this FIG. 2C, step 2002 comprises obtaining first quality-of-service (QoS) information associated with a first communication session between a first communication device and a radio element of a wireless network, the first communication session comprising a first communication that is transmitted from the first communication device to the radio element. Next, step 2004 comprises determining, based at least in part upon the first QoS information, whether the first communication is to be processed by one or more first servers of an edge node of a packet core network, the determining resulting in a first determination. Next, step 2006 comprises responsive to the first determination being that the first communication is to be processed by the one or more first servers of the edge node, directing the first communication from the radio element to the edge node, the directing of the first communication to the edge node facilitating a providing of a first latency to the first communication. Next, step 2008 comprises responsive to the first determination being that the first communication is not to be processed by the one or more first servers of the edge node, directing the first communication from the radio element to one or more second servers of another node of the packet core network, the directing of the first communication to the another node facilitating a providing of a second latency to the first communication.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2D, various steps of a method 2100 according to an embodiment are shown. As seen in this FIG. 2D, step 2102 comprises receiving, from a mobile radio network that is engaged in communications with a mobile communication device, a group of one or more packets, the communications having associated therewith a quality-of-service (QoS) indicator. Next, step 2104 comprises determining, based at least in part upon the QoS indicator, whether the group of the one or more packets is to be processed with a lowest available latency, the determining resulting in a determination. Next, step 2106 comprises responsive to the determination being that the group of the one or more packets is to be processed with the lowest available latency, processing the group of the one or more packets at the edge node, the processing of the group of the one or more packets at the edge node resulting in a first latency, and the first latency including a first transit time to the edge node. Next, step 2108 comprises responsive to the determination being that the group of the one or more packets is not to be processed with the lowest available latency, directing the group of the one or more packets to another node of the computer network for processing at the another node, the directing of the group of the one or more packets to the another node resulting in a second latency, the second latency including a second transit time to the another node, and the second latency being longer than the first latency.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2E, various steps of a method 2200 according to an embodiment are shown. As seen in this FIG. 2E, step 2202 comprises obtaining from a wireless network, by a first edge node comprising a first processing system including a first processor, first quality-of-service (QoS) information associated with a first communication, the first communication being sent from a wireless communication device to the wireless network, the first edge node being part of a packet core network. Next, step 2204 comprises obtaining, by the first edge node, first data indicative of a first plurality of latency values between a first uniform resource locator (URL) and the first edge node. Next, step 2206 comprises obtaining, by the first edge node, second data indicative of a second plurality of latency values between a second URL and the first edge node, the second URL being a different URL from the first URL. Next, step 2208 comprises determining, by the first edge node, based at least in part upon the first QoS information, the first data, and the second data whether the first communication is to be processed by the first edge node for return by the first edge node of a first return communication. Next, step 2210 comprises responsive to determining that the first communication is to be processed by the first edge node for return by the first edge node of a first return communication: generating, by the first edge node, the first return communication; and transmitting, by the first edge node, the first return communication for receipt by the wireless communication device via the wireless network. Next, step 2212 comprises obtaining from a wired network, by a second edge node comprising a second processing system including a second processor, second QoS information associated with a second communication, the second communication being sent from a wired communication device to the wired network, the second edge node being part of the packet core network Next, step 2214 comprises obtaining, by the second edge node, third data indicative of a third plurality of latency values between a third URL and the second edge node. Next, step 2216 comprises obtaining, by the second edge node, fourth data indicative of a fourth plurality of latency values between a fourth URL and the second edge node, the fourth URL being a different URL from the third URL. Next, step 2218 comprises determining, by the second edge node, based at least in part upon the second QoS information, the third data, and the fourth data whether the second communication is to be processed by the second edge node for return by the second edge node of a second return communication. Next, step 2220 comprises responsive to determining that the second communication is to be processed by the second edge node for return by the second edge node of a second return communication: generating, by the second edge node, the second return communication; and transmitting, by the second edge node, the second return communication for receipt by the wired communication device via the wired network.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, another embodiment relates to real-time latency of data communication that occurs between devices (e.g., mobile devices) and remote servers (typically outside of the mobile carrier's network). In this context, latency is therefore variable to each uniform resource locator (URL) involved. However, a common component of latency is associated with the location of an edge node and its interconnectivity through the carrier's gateways and firewall out to, for example, the world wide web. In various embodiments, a particular edge node's component of latency can be estimated dynamically. Such latency can also be quantified as a function of time of day and the day of the week. Each edge node can host an internal function to make IP connections to a collection of URLs specifically for the purpose of measuring real-time latency (which affects all devices connected to the particular edge node). For instance, in a hypothetical example, the minimum latency to ESPN.com from a particular edge node measured over the last 30 days could be 50 milliseconds round-trip. However (in this hypothetical example), the average latency on Monday between 2-3 pm could be 60 milliseconds and the latest latency to ESPN.com in the last minute might be 120 milliseconds. The ESPN.com URL of this example could be one of many used to make an overall assessment of current latency for the particular edge node. This dynamic information about latency can be used to bias which QoS types are processed locally in the particular edge node or are instead routed to a longer-latency (but more cost-efficient) processing location (e.g., a node that is deeper in the network). Further, this capability enables comparison of real-time latency measures versus historical, statistical measures (e.g., for the purpose of alerting and/or alarms). In one specific example, if a latency for a particular edge node rises above a threshold (e.g., more than x milliseconds greater than an average over y prior minutes, or more than k percent greater than an average over m prior minutes) then an alert can be generated (e.g., an alert to an operator of the network to cause the operator to investigate and/or rectify the high latency).

As described herein, various embodiments can provide for: (a) one or more communications to be processed at an edge node (e.g., wherein the decision to process at the edge node is based at least in part upon one or more quality-of-service parameters associated with the one or more communications); (b) one or more communications to be processed at a middle (or intermediate) node (e.g., wherein the decision to process at the middle (or intermediate) node is based at least in part upon one or more quality-of-service parameters associated with the one or more communications); and/or (c) one or more communications to be processed at a centralized node (e.g., wherein the decision to process at the centralized node is based at least in part upon one or more quality-of-service parameters associated with the one or more communications).

As described herein, various embodiments can provide for dynamically moving processing from an edge of a network (e.g., an edge node of a computer network) deeper into the network. In one example, the edge node that receives the communication (e.g., from a wireless communications network) can make the decision whether to process the communication at the edge node itself or to send the communication deeper into the network to be processed.

As described herein, various embodiments can provide for routing (and/or re-routing) certain data type(s) that can handle worse latency (e.g., higher latency) to one or more lower-cost locations (that is, one or more locations that can perform the processing at a lower cost).

As described herein, various embodiments can provide for routing decision(s) to be triggered off-of quality-of-service parameter(s). Such routing decisions can indicate that a node is to process a communication locally or to send the communication further (e.g., deeper) into a network for processing.

As described herein, various embodiments can provide for all traffic to initially go to an edge node (e.g., from a radio element of a wireless communication network). At the edge node a decision can be made to process the communication there (at the edge node) or to re-route the communication to another node (in one example, the routing/re-routing decisions(s) can be made dynamically). In one embodiment, after a particular communication is sent from an edge node to another node (e.g., a middle or intermediate node) for processing, the middle (or intermediate) node can make its own decision whether to process the communication there (at the middle (or intermediate node)) or to re-route the communication to yet another node (e.g., a centralized node). In one example, processing at a particular node can comprise generating a response to the communication and sending the response back up through the network to be sent by the radio element of the wireless network to the originating communication device (that is, the communication device that had sent the particular communication in the first place).

As described herein, various embodiments can provide for a routing/re-routing decision to be made by an element of a wireless communications network (e.g., a server associated with a radio element) based at least in part upon historical latency data and/or real-time latency data. Other embodiments can provide for a routing/re-routing decision to be made by a particular node (e.g., an edge node, a middle (or intermediate) node, or a centralized node based at least in part upon historical latency data and/or real-time latency data. In various examples, the historical and/or real-time latency data can comprise minimum latency, average latency, and/or most recent latency.

As described herein, various embodiments can provide systems and methods for selective allocation of processing resources based on QoS class. Such systems and methods can be applied to any desired telephonic and/or data communications networks worldwide (e.g., mobile networks and/or wired networks). Various embodiments can be applied to any desired consumer, commercial, and/or governmental systems.

As described herein, provision of communications services is typically an increasingly commoditized business with decreasing profit margins. For one nationwide carrier, a large percentage of its communications network is on the radio-access side while another large percentage of its communications network is the core network. The core networks are increasingly IP-based with server-based processing (as opposed to legacy circuit-switched core nodes). Reducing the expenses of server farms around the country can be a critical factor for overall financials for any communications carrier. Various embodiments described herein likely reduce the costs of server capital, facilities, and maintenance. For a large carrier, various embodiments can provide a significant annual savings. In addition to cost savings, various embodiments can provide a revenue opportunity (for example, from gaming users and/or from gaming providers—each of which has an interest in having the lowest latency for an optimized gaming experience and each of which might be willing to pay to have such gaming services connected to an EDGE location (wherein such EDGE location may also have direct connect (or virtually direct connect) to one or more gaming servers)).

As described herein, various embodiments can provide for automated processing allocation for QoS-specific communications.

As described herein, various embodiments can provide for a system and a method that optimize the allocation of communications processing in a communications network. Varying QoS types (classes) of communications can be automatically allocated to different processing server locations based on tradeoffs between the technical needs of the communication QoS type (or class) and the cost of provision to the provider and/or carrier.

As described herein, various embodiments can address a type of Nash-equilibrium problem where an optimum outcome cannot be achieved if all users of resources try to use the best resource. In a Nash equilibrium, the optimum outcome is achieved when each user of resources uses only the required resources, but no more. This frees the better resources (also typically the more expensive resources) only for those takers genuinely requiring them.

Reference will now be made to certain scenarios in which various embodiments can provide benefits. For example, one scenario can involve use of a mobile network that has been fully converted to 5G. For certain conventional 5G deployment approaches, a large nationwide carrier may need to provide 1000 edge locations with each having enough servers to support roughly 130,000 devices. Each edge location would experience peak usage based on its time zone. When servers at an edge location on the East coast are substantially idled at 10 pm, those servers on the West coast are still in high demand at 7 pm. This geographic difference in peak usage times causes inefficiencies in computing resources. Various embodiments can recover much of the inefficiency. For instance, via use of various embodiments, each of the edge locations would only require computing resources for the most latency-intolerant communications. Such communications may be (for example) less than 5% of total communications. In this example, instead of needing perhaps 100 servers at each location, 5 may suffice. This gives a carrier much more latitude to acquire a low-cost facility. Communications requiring moderate latency such as interactive-background web browsing could be routed to perhaps 50-100 locations having a greater number of servers with improved economies of scale. Lastly, highly latency-tolerant communications could be routed to one of perhaps 10-15 locations with even better economies of scale.

In various embodiments, to the extent a device (e.g., a mobile device) is conducting simultaneous communications utilizing a plurality of communication types having different QoS classes, each class can be independently routed to the optimum location (e.g., to minimize carrier costs while meeting service level requirements for all communications).

In other examples, certain users may require latency based on device identity, rather than exclusively the QoS class for communication. For instance, certain FirstNet or law enforcement communications could be dictated by the FCC or other administrative or legislative entities to receive the lowest-possible latency. Various embodiments can override the QoS-indicated processing location in a manner comparable to whitelisting a phone number. In still other embodiments, a mechanism can be provided to enable a maximum latency to be prescribed (as opposed to requiring the best possible latency).

In various embodiments, a mechanism can be provided to enable communications to temporarily use the best latency currently available, while monitoring the available capacity margin for each edge or intermediate location. When the available capacity margin at any location drops below a prescribed threshold, device communications can be dynamically re-routed to processing locations having greater latency. Communication re-routes can be prioritized based on QoS class. This can enable an operator to provide the best customer experience as often as possible, but when the lowest-latency resources become overused, there can be a selective redirection of communications bearers which can tolerate greater latency.

In another embodiment, any edge node (see, e.g., Edge Nodes 204, 206, 208, 222, 224, 226 of FIG. 2A) receiving a communication can make its own decision as to whether to process a given communication at the node or to direct the communication deeper into the network (where, for example, the given communication can be processed at a lower cost and with a higher latency).

As described herein, some communication types (or applications) require low latency. Examples of such communication types (or applications) that require low latency include on-line (real-time) gaming, real-time decision systems (e.g., for stock trading), and certain forms of manufacturing (such as implemented utilizing real-time communications). Other communication types (or applications) do not require low latency. Examples of such communication types (or applications) that do not require low latency include transferring files, watching videos, or accessing email. Still other communication types (or applications) reside in the middle. These include interactive browsing of web pages—for instance, a visit to CNN.com may involve transmission of 30 or more web page objects, each of which requires object transfer acknowledgements; the round-trip time for communications is therefore amplified by the number of acknowledgements required before the web page download is complete. Various embodiments described herein can provide mechanisms to optimize use of network resources based upon latency requirements of various communication types (or applications)

As described herein, various embodiments can provide an extension to a conventional concept in mobile radio networks of QoS-based bearer types and an extension to a certain conventional concept for a similar QoS class in broadband wired networks with SD-WAN (Software Defined Wide Area Networks). Such an extension can provide (according to various embodiments) for allocating resources (e.g., nodes in a network) and directing communications to certain node(s).

As described herein, various embodiments can provide a method comprising: obtaining from a radio element of a mobile radio network, by a processing system including a processor, first quality-of-service (QoS) information associated with a first communication, the first communication being from a first communication device to the radio element; determining, by the processing system, based at least in part upon the first QoS information, whether the first communication is to be processed with a lowest available latency; responsive to determining that the first communication is to be processed with the lowest available latency, directing, by the processing system, the first communication from the radio element to one or more first servers of an edge node of a computer network, the directing of the first communication to the edge node facilitating a providing of a first latency to the first communication; obtaining from the radio element of the mobile radio network, by the processing system, second QoS information associated with a second communication, the second communication being from a second communication device to the radio element; determining, by the processing system, based at least in part upon the second QoS information, whether the second communication is to be processed with the lowest available latency; responsive to determining that the second communication is not to be processed with the lowest available latency, determining, by the processing system, based at least in part upon the second QoS information, whether the second communication is to be processed with a second lowest available latency; responsive to determining that the second communication is to be processed with the second lowest available latency, directing, by the processing system, the second communication from the radio element to one or more second servers of an intermediate node of the computer network, the directing of the second communication to the intermediate node facilitating a providing of a second latency to the second communication, the second latency being longer than the first latency; obtaining from the radio element of the mobile radio network, by the processing system, third QoS information associated with a third communication, the third communication being from a third communication device to the radio element; determining, by the processing system, based at least in part upon the third QoS information, whether the third communication is to be processed with a third lowest available latency; and responsive to determining that the third communication is to be processed with the third lowest available latency, directing, by the processing system, the third communication from the radio element to one or more third servers of a centralized node of the computer network, the directing of the third communication to the centralized node facilitating a providing of a third latency to the third communication, the third latency being longer than the second latency.

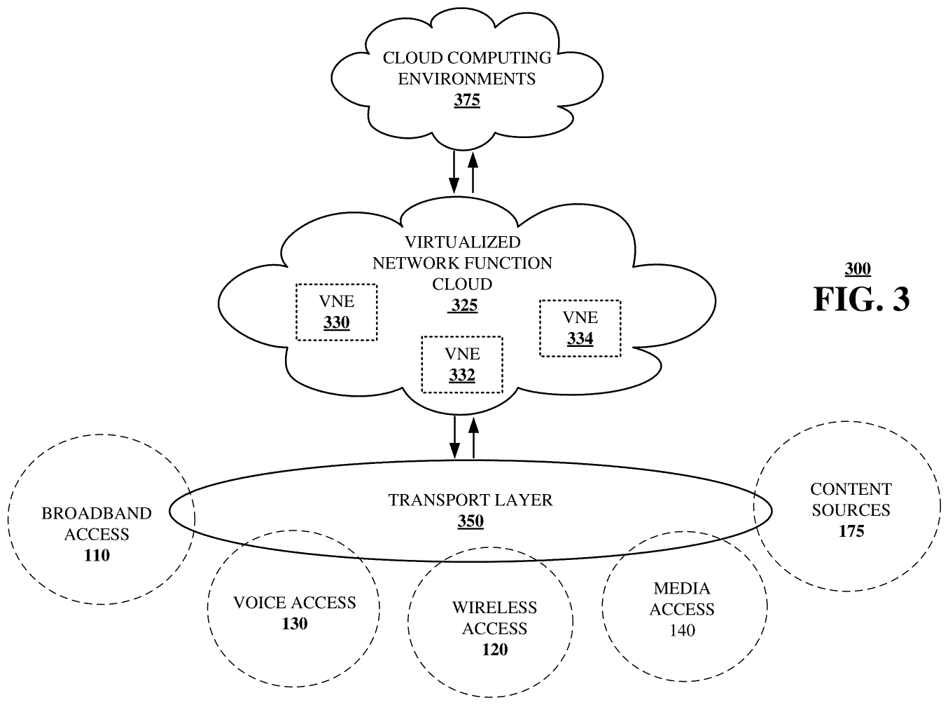

Referring now to FIG. 3, a block diagram 300 is shown illustrating an example, non-limiting embodiment of a virtualized communication network in accordance with various aspects described herein. In particular, a virtualized communication network is presented that can be used to implement some or all of the subsystems and functions of system 100 of FIG. 1, some or all of the subsystems and functions of system 200 of FIG. 2A, some or all of the subsystems and functions of system 250 of FIG. 2B, some or all of the functions of method 2000 of FIG. 2C, some or all of the functions of method 2100 of FIG. 2D, and/or some or all of the functions of method 2200 of FIG. 2E. For example, virtualized communication network 300 can facilitate in whole or in part automatic allocation of one or more resources (e.g., one or more computer server resources at a particular network node) to a communication in accordance with a quality-of-service parameter associated with the communication.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

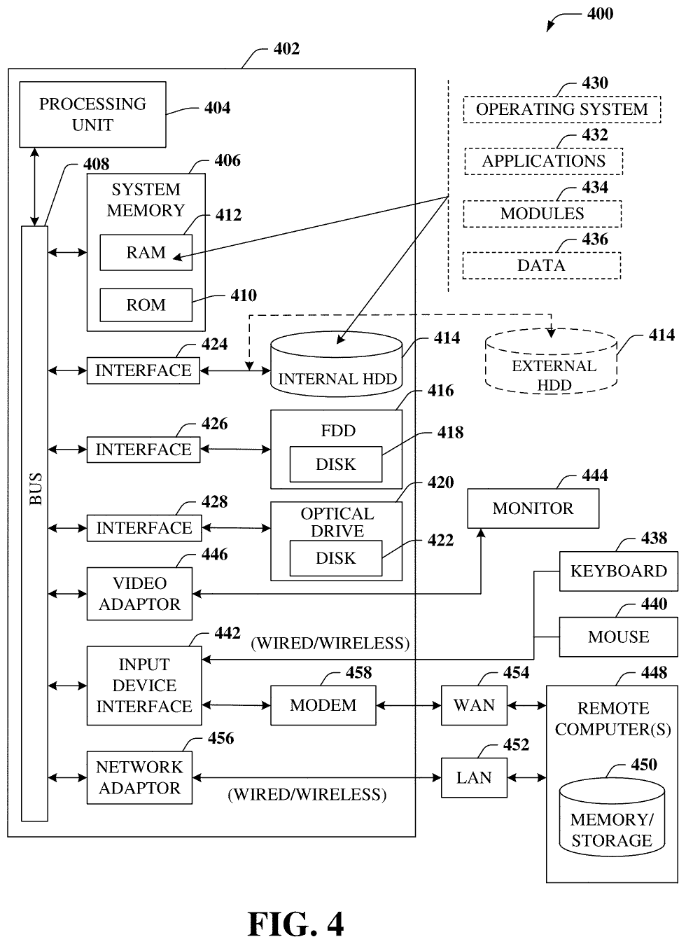

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part automatic allocation of one or more resources (e.g., one or more computer server resources at a particular network node) to a communication in accordance with a quality-of-service parameter associated with the communication.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

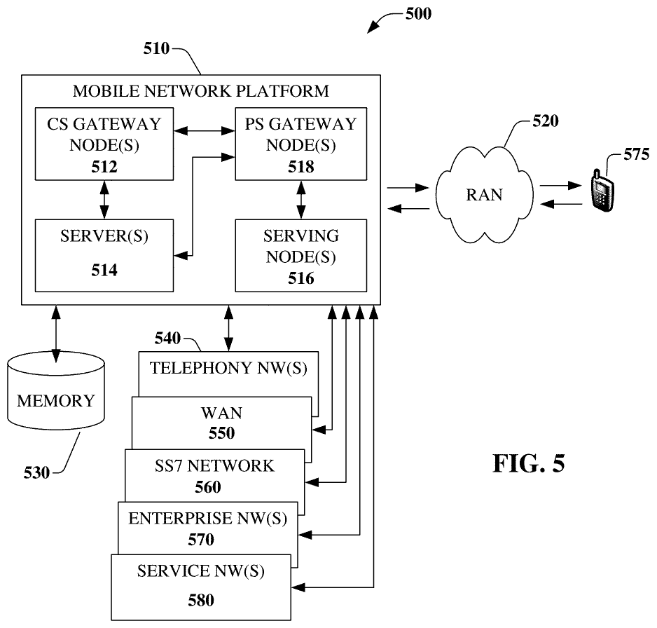

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part automatic allocation of one or more resources (e.g., one or more computer server resources at a particular network node) to a communication in accordance with a quality-of-service parameter associated with the communication. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

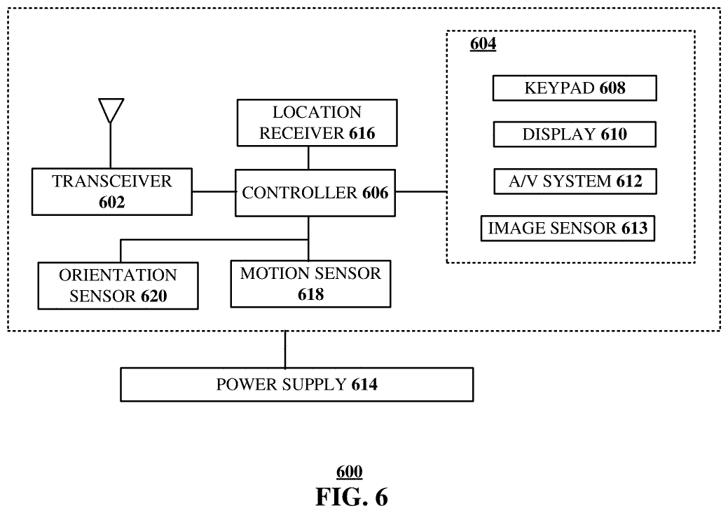

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via communications network 125. For example, computing device 600 can facilitate in whole or in part automatic allocation of one or more resources (e.g., one or more computer server resources at a particular network node) to a communication in accordance with a quality-of-service parameter associated with the communication.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically allocating one or more resources (e.g., one or more computer server resources at a particular network node) to a communication in accordance with a quality-of-service parameter associated with the communication) can employ various AI-based schemes for carrying out various embodiments thereof. Moreover, the classifier can be employed to determine a ranking or priority of one or more communications (e.g., one or more communications with a mobile communication device), one or more communication sessions (e.g., one or more communication sessions with a mobile communication device) and/or one or more resources (e.g., one or more computer server resources at a particular network node). A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria a ranking or priority of one or more communications (e.g., one or more communications with a mobile communication device), one or more communication sessions (e.g., one or more communication sessions with a mobile communication device) and/or one or more resources (e.g., one or more computer server resources at a particular network node).

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
obtaining first quality-of-service (QoS) information associated with a first communication session between a first communication device and a radio element of a wireless network, the first communication session comprising a first communication that is transmitted from the first communication device to the radio element;
determining, based at least in part upon the first QoS information, whether the first communication is to be processed by one or more first servers of an edge node of a packet core network, the determining resulting in a first determination;
responsive to the first determination being that the first communication is to be processed by the one or more first servers of the edge node, directing the first communication from the radio element to the edge node, the directing of the first communication to the edge node facilitating a providing of a first latency to the first communication; and
responsive to the first determination being that the first communication is not to be processed by the one or more first servers of the edge node, directing the first communication from the radio element to one or more second servers of another node of the packet core network, the directing of the first communication to the another node facilitating a providing of a second latency to the first communication.

2. The device of claim 1, wherein:
the first latency and the second latency each comprises a respective one-way latency;
the first latency is lower than the second latency; and
the first determination is a result of the first QoS information indicating that the first communication should receive a lowest available latency.

3. The device of claim 1, wherein:
the first communication is directed to a particular uniform resource locator (URL);
the operations further comprise obtaining first data indicative of one or more first historical latency values between the URL and the one or more first servers of the edge node;
the operations further comprise obtaining second data indicative of one or more second historical latency values between the URL and the one or more second servers of the another node; and
the determining is further based upon the first data and the second data.

4. The device of claim 3, wherein the first determination results in providing a lowest available latency to the first communication, the lowest available latency taking into account the first historical latency values and the second historical latency values.

5. The device of claim 1, wherein:
the first QoS information is indicative of a type of service; and
the type of service is one of:
a real-time gaming service;
a real-time decision making service;
a real-time manufacturing service;
a voice calling service;
a web browsing service;
a video streaming service;
a file transfer protocol (FTP) service;
an email service; or
a text messaging service.

6. The device of claim 5, wherein:
in a first case that the first QoS information is indicative of the real-time gaming service, then the first determination is that the first communication is to be processed by the one or more first servers of the edge node;
in a second case that the first QoS information is indicative of the real-time decision making service, then the first determination is that the first communication is to be processed by the one or more first servers of the edge node;
in a third case that the first QoS information is indicative of the real-time manufacturing service, then the first determination is that the first communication is to be processed by the one or more first servers of the edge node;
in a fourth case that the first QoS information is indicative of the voice calling service, then the first determination is that the first communication is to be processed by the one or more first servers of the edge node;
in a fifth case that the first QoS information is indicative of the web browsing service, then the first determination is that the first communication is not to be processed by the one or more first servers of the edge node;
in a sixth case that the first QoS information is indicative of the video streaming service, then the first determination is that the first communication is not to be processed by the one or more first servers of the edge node;
in a seventh case that the first QoS information is indicative of the FTP service, then the first determination is that the first communication is not to be processed by the one or more first servers of the edge node;
in an eighth case that the first QoS information is indicative of the email service, then the first determination is that the first communication is not to be processed by the one or more first servers of the edge node; and
in a ninth case that the first QoS information is indicative of the text messaging service, then the first determination is that the first communication is not to be processed by the one or more first servers of the edge node.

7. The device of claim 1, wherein:
the first communication device is a mobile device;
the first QoS information comprises an indicator associated with a radio bearer request made by the mobile device while the mobile device is in communication with the wireless network; and
the processing system is part of the wireless network.

8. The device of claim 1, wherein, in a case that the first determination is that the first communication is to be processed by the one or more first servers of the edge node, the first communication is directed to the edge node such that the first communication goes to the one or more first servers without transiting through any other server of the packet core network.

9. The device of claim 1, wherein, in a case that the first determination is that the first communication is not to be processed by the one or more first servers of the edge node, the first communication is directed to the another node of the packet core network such that the first communication goes to the one or more second servers without transiting through the one or more first servers.

10. The device of claim 1, wherein, in a case that the first determination is that the first communication is not to be processed by the one or more first servers of the edge node, the first communication is directed to the another node of the packet core network such that the first communication goes to the one or more second servers after transiting through the one or more first servers.

11. The device of claim 1, wherein:
in a case that the first determination is that the first communication is to be processed by the one or more first servers of the edge node:
a processing by the one or more first servers of the edge node comprises generating a return communication in response to the first communication; and
the operations further comprise receiving from the one or more first servers of the edge node the return communication that is responsive to the first communication.

12. The device of claim 11, wherein the operations further comprise:
providing the return communication for use by the radio element of the wireless network to facilitate sending of the return communication from the radio element to the first communication device;
wherein the first latency comprises a round-trip latency associated with both the first communication and the return communication.

13. The device of claim 1, wherein:
in a case that the first determination is that the first communication is not to be processed by the one or more first servers of the edge node:
a processing by the one or more second servers of the another node comprises generating a return communication in response to the first communication; and
the operations further comprise receiving from the one or more second servers of the another node the return communication that is responsive to the first communication.

14. The device of claim 13, wherein the operations further comprise:
providing the return communication for use by the radio element of the wireless network to facilitate sending of the return communication from the radio element to the first communication device;
wherein the second latency comprises a round-trip latency associated with both the first communication and the return communication.

15. The device of claim 1, wherein the operations further comprise:
obtaining second QoS information associated with a second communication session between a second communication device and the radio element of the wireless network, the second communication session comprising a second communication that is transmitted from the second communication device to the radio element;
determining, based at least in part upon the second QoS information, whether the second communication is to be processed by the one or more first servers of the edge node of the packet core network, the determining resulting in a second determination;
responsive to the second determination being that the second communication is to be processed by the one or more first servers of the edge node, directing the second communication from the radio element to the edge node, the directing of the second communication to the edge node facilitating a providing of a third latency to the second communication; and
responsive to the second determination being that the second communication is not to be processed by the one or more first servers of the edge node, directing the second communication from the radio element to the one or more second servers of the another node of the packet core network, the directing of the second communication to the another node facilitating a providing of a fourth latency to the second communication.

16. A non-transitory machine-readable medium comprising executable instructions that, when executed by a processing system including a processor, facilitate performance of operations, the processing system being part of an edge node of a computer network, the operations comprising:
receiving, from a mobile radio network that is engaged in communications with a mobile communication device, a group of one or more packets, the communications having associated therewith a quality-of-service (QoS) indicator;
determining, based at least in part upon the QoS indicator, whether the group of the one or more packets is to be processed with a lowest available latency, the determining resulting in a determination;
responsive to the determination being that the group of the one or more packets is to be processed with the lowest available latency, processing the group of the one or more packets at the edge node, the processing of the group of the one or more packets at the edge node resulting in a first latency, and the first latency including a first transit time to the edge node; and
responsive to the determination being that the group of the one or more packets is not to be processed with the lowest available latency, directing the group of the one or more packets to another node of the computer network for processing at the another node, the directing of the group of the one or more packets to the another node resulting in a second latency, the second latency including a second transit time to the another node, and the second latency being longer than the first latency.

17. The non-transitory machine-readable medium of claim 16, wherein:
the QoS indicator is indicative of a class of application that is running on the mobile communication device;
the class of application is one of:
a real-time gaming application;
a real-time decision making application;
a real-time manufacturing application;
a voice calling application;
a web browsing application;
a video streaming application;
a file transfer protocol (FTP) application;
an email application; or
a text messaging application;
in a first case that the QoS indicator is indicative of the real-time gaming application, then the determination is that the group of the one or more packets is to be processed with the lowest available latency;
in a second case that the QoS indicator is indicative of the real-time decision making application, then the determination is that the group of the one or more packets is to be processed with the lowest available latency;
in a third case that the QoS indicator is indicative of the real-time manufacturing application, then the determination is that the group of the one or more packets is to be processed with the lowest available latency;
in a fourth case that the QoS indicator is indicative of the voice calling application, then the determination is that the group of the one or more packets is to be processed with the lowest available latency;
in a fifth case that the QoS indicator is indicative of the web browsing application, then the determination is that the group of the one or more packets is not to be processed with the lowest available latency;
in a sixth case that the QoS indicator is indicative of the video streaming application, then the determination is that the group of the one or more packets is not to be processed with the lowest available latency;
in a seventh case that the QoS indicator is indicative of the FTP application, then the determination is that the group of the one or more packets is not to be processed with the lowest available latency;
in an eighth case that the QoS indicator is indicative of the email application, then the determination is that the group of the one or more packets is not to be processed with the lowest available latency; and
in a ninth case that the QoS indicator is indicative of the text messaging application, then the determination is that the group of the one or more packets is not to be processed with the lowest available latency.

18. The non-transitory machine-readable medium of claim 16, wherein:
the QoS indicator is associated with a radio bearer request made by the mobile communication device while the mobile communication device is in communication with the mobile radio network;
in a first case that the determination is that the group of the one or more packets is to be processed with the lowest available latency:
the processing of the group of the one or more packets at the edge node comprises generating an edge node return communication in response to the group of the one or more packets; and
in a second case that the determination is that the group of the one or more packets is not to be processed with the lowest available latency:
the processing at the another node of the group of the one or more packets comprises generating another node return communication in response to the group of the one or more packets.

19. A method comprising:
obtaining from a wireless network, by a first edge node comprising a first processing system including a first processor, first quality-of-service (QoS) information associated with a first communication, the first communication being sent from a wireless communication device to the wireless network, the first edge node being part of a packet core network;
obtaining, by the first edge node, first data indicative of a first plurality of latency values between a first uniform resource locator (URL) and the first edge node;
obtaining, by the first edge node, second data indicative of a second plurality of latency values between a second URL and the first edge node, the second URL being a different URL from the first URL;
determining, by the first edge node, based at least in part upon the first QoS information, the first data, and the second data whether the first communication is to be processed by the first edge node for return by the first edge node of a first return communication;
responsive to determining that the first communication is to be processed by the first edge node for return by the first edge node of a first return communication:
generating, by the first edge node, the first return communication; and
transmitting, by the first edge node, the first return communication for receipt by the wireless communication device via the wireless network;
obtaining from a wired network, by a second edge node comprising a second processing system including a second processor, second QoS information associated with a second communication, the second communication being sent from a wired communication device to the wired network, the second edge node being part of the packet core network;
obtaining, by the second edge node, third data indicative of a third plurality of latency values between a third URL and the second edge node;
obtaining, by the second edge node, fourth data indicative of a fourth plurality of latency values between a fourth URL and the second edge node, the fourth URL being a different URL from the third URL;
determining, by the second edge node, based at least in part upon the second QoS information, the third data, and the fourth data whether the second communication is to be processed by the second edge node for return by the second edge node of a second return communication;
responsive to determining that the second communication is to be processed by the second edge node for return by the second edge node of a second return communication:
generating, by the second edge node, the second return communication; and
transmitting, by the second edge node, the second return communication for receipt by the wired communication device via the wired network.

20. The method of claim 19, wherein:
the first edge node is a same edge node as the second edge node; and
the method further comprises:
responsive to determining that the first communication is not to be processed by the first edge node for return by the first edge node of the first return communication:
directing the first communication to a first other node of the packet core network; and
responsive to determining that the second communication is not to be processed by the second edge node for return by the second edge node of the second return communication:
directing the second communication to a second other node of the packet core network.
